(19) United States
(12) Patent Application Publication
(10) Pub. No.: US 2003/0165058 A1
(43) Pub. Date: Sep. 4, 2003

(54) Hazardous location induction lighting fixture

(75) Inventor: Robert H. Osborn JR., Collierville, TN (US)

Correspondence Address: HOFFMANN & BARON, LLP, 6900 JERICHO TURNPIKE, SYOSSET, NY, 11791, US

(73) Assignee: Thomas & Betts International, Inc.

(21) Appl. No.: 10/364,976

(22) Filed: Feb. 12, 2003

Related U.S. Application Data
(60) Provisional application No. 60/357,217, filed on Feb. 15, 2002.
(60) Provisional application No. 60/370,973, filed on Apr. 9, 2002.

(51) Int. Cl. F21K 2/00

(52) U.S. Cl. 362/265; 362/267; 362/310; 362/363

(57) ABSTRACT

The present invention is a hazardous location induction lighting fixture. The light fixture has a tank having a base with parametrically side walls terminating at a rim to define the interior portion. The interior portion further includes at least one tank extension extending from the base to support a ballast plate. A ballast plate is used as a heat sink to which a induction light assembly is attached. The induction light assembly is electrically connected to an induction lamp which is positioned on the outer of the tank to emit light. A refractor assembly is selectively securable to the tank to enclose the induction lamp and in a preferred embodiment can be sealably secured to the tank to prevent fluids or dusts from entering the lamp.

### CROSS REFERENCE TO RELATED APPLICATIONS

This application claims the benefit of U.S. Provisional Application No. 60/357,217 filed on Feb. 15, 2002, and U.S. Provisional Application No. 60/370,973 filed on Apr. 9, 2002 the disclosures of which are incorporated herein by reference.

### BACKGROUND OF THE INVENTION

The present invention relates generally to the lighting fixture and more particularly to a induction lighting system used for a hazardous location light.

Prior hazardous location lighting fixtures typically use a high intensity discharge light system. These high intensity discharge (hereinafter “HID”) light systems are known in the art. The HID lights are typically used since they provide a lighting source which provides sufficient brightness and illumination for the areas in which hazardous light fixtures are used. Another reason for using HID lights, is that the light fixtures typically do not discharge a high amount of heat which is important in a hazardous light location where a high temperature light could create a safety problem if the light were to become hot. The reason for this safety concern is that hazardous location light fixtures are sometimes used in places where either a flammable gas, vapor or dust may be present and a high temperature light fixture which produces an excessive amount of heat or where the bulb itself becomes extremely hot could potentially ignite the hazardous gas, vapor or dust.

Although HID lights are satisfactory in some hazardous location lighting fixtures, the disadvantage with HID lights is that they have a short bulb life span of approximately 10,000 to 20,000 hours of usage. HID light fixtures can be used in locations where multiple fixtures are installed. The cost for replacing them every few years is extremely expensive. The expense of changing these bulbs is increased since hazardous light fixtures are used in locations where the ceilings are at a very high height, sometimes 20 to 30 feet above the ground, and the act of changing a single bulb or multiple bulbs is both very time consuming and expensive.

There exists a need for a hazardous light fixture which uses a bulb which has a life expectancy much greater than a typical HID bulb. There is also a need for a light fixture that can be used in a hazardous location fixture which does not produce an excessive amount of heat and is still safe to use in the same locations where a HID light fixture would be used.

In addition, there exists a need for a hazardous location lighting fixture which can be used with current existing hazardous location lighting fixtures with only minor modifications to further reduce costs associated with replacing bulbs.

### SUMMARY OF THE INVENTION

The present invention provides a hazardous lighting fixture which can be used with present hazardous light fixtures which use HID lights, however, the present invention allows the use of an induction lighting system instead of the HID system to provide longer life. The present invention allows the use of induction light system which are known to have a much longer life expectancy than HID systems and have an approximate lifetime expectancy of up to 100,000 hours of continuous use. The present invention allows an induction light system to be used with a pre-existing tank and refractor assembly of hazardous lights using HID bulbs.

The present invention is a hazardous lighting fixture having a tank with a base parametrically bounded by side walls terminating at a rim to define an interior portion. The interior portion contains at least one tank extension extending from the base to support a ballast plate. The ballast plate is attached to the at least one tank extension and can be made of aluminum. The interior of the tank also houses an induction light assembly which is attached to both the ballast plate and tank. An induction lamp is operatively connected to the induction light assembly and is preferably positioned on the outer surface of the tank to emit light. A refractor assembly is selectively securable to the tank to enclose the induction lamp and allows light shine there through.

In a preferred embodiment the induction light assembly can include a high frequency generator positioned on the ballast plate for electrical connection to the induction lamp. The induction light assembly further includes a lamp mount heat sink positioned on the outer surface of the base of the tank to allow the attachment of the induction lamp thereto. In a more preferred embodiment the induction lamp and induction light assembly used is a Philips QL Induction Light®.

However, it is envisioned that any type of induction lamp suitable for hazardous locations can be used. The refractor assembly of the present invention is removably securable to the tank on the base to enclose the induction lamp. The refractor assembly can be removed when needed for periodic cleaning and maintenance. In a preferred embodiment the refractor assembly includes a reflector which is removably securable at a first end to the tank. A second opposite end of the reflector is adapted for receiving a translucent refractor glass. It is envisioned that in the preferred embodiment that both the reflector and the refractor glass are sealably attached to the tank to form a fluid-tight seal to prevent dusts and fluids from contacting the induction lamp.

An advantage of the present invention is that it uses a modified lamp mount heat sink and ballast mount bracket which can be attached to pre-existing hazardous light systems to allow the use of the induction light system.

A further advantage of the present invention is that it uses components which dissipate the additional heat created by the induction light so that the heat created by the induction light bulb does not create a hazardous condition or an extreme temperature where the bulb will no longer operate. The present invention is constructed so that pre-existing HID light fixtures can be easily modified to accept these fixtures without excessive cost.

A still further advantage of the present invention is that it provides a cost effective alternative for hazardous lighting fixture so that the need for changing bulbs is greatly reduced and the inconvenience of changing bulbs is also greatly reduced.

For a better understanding of the present invention, together with other and further advantages, reference is made to the following detailed description, taken in conjunction with the accompanying drawings, and the scope of the invention will be pointed out in the appended claims.

### BRIEF DESCRIPTION OF THE DRAWINGS

FIG. 1 is a partial cross section of a standard prior art high intensity discharge light fixture;

FIG. 2 is a side elevational view cross section of the present invention using an induction light system;

FIG. 3 is a front elevational view cross section of the present invention using an induction light system;

FIG. 4 is a side elevational view cross section of the present invention using an induction light system as shown in FIG. 1 with the bulb removed for clarity;

FIG. 5 is an exploded view of the present invention using an induction light system;

FIG. 6 is a side elevational view cross section of an alternative embodiment of the present invention using an induction light system; and

FIG. 7 is a front elevational view cross section of an alternative embodiment the present invention using an induction light system.

### DETAILED DESCRIPTION OF THE PREFERRED EMBODIMENTS

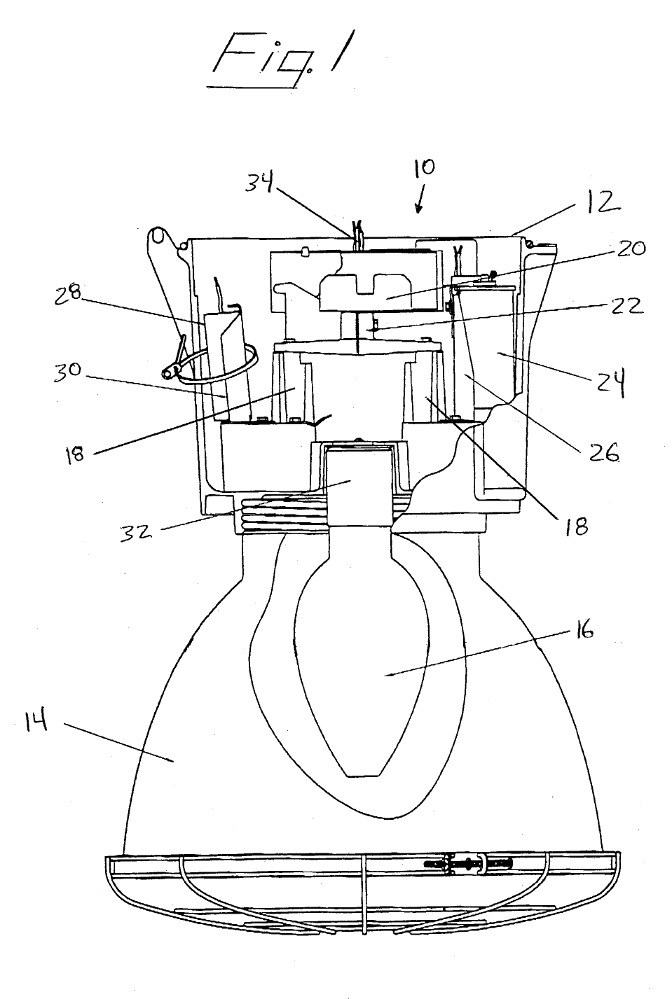

Referring to FIG. 1, a prior art HID fixture 10 is shown. The HID fixture has a fixture tank 12 to house the components of the lamp. The tank 12 can be a Hazlux H3® HID fixture which is known in the art. Attached to the tank 12 is a reflective dome 14 which houses a HID lamp bulb 16. The bulb 16 is attached to the tank 12 with a screw socket 32 contained within the tank 12. The tank 12 has a plurality of tank extensions 18 which are integrally molded into the tank 12 and are known in the art and are a standard feature. The tank extensions 18 have attached on the top of them ballast brackets 22 which support a ballast 20 connected to the bulb 16 to hold it in place. In order to operate an HID light, various components such a capacitor 24, capacitor bracket 26, igniter 28 and igniter bracket 30, which holds the igniter 28 to the tank 12, is needed to be housed within the tank 12 in order for the HID lamp 16 to function. After being assembled, the tank 12 is then attached to the fixture where the lead wires 34 are than attached to the electricity in the building. As shown in FIG. 1, the standard HID hazardous light fixture contains many components which need to be assembled in order for the lamp to function.

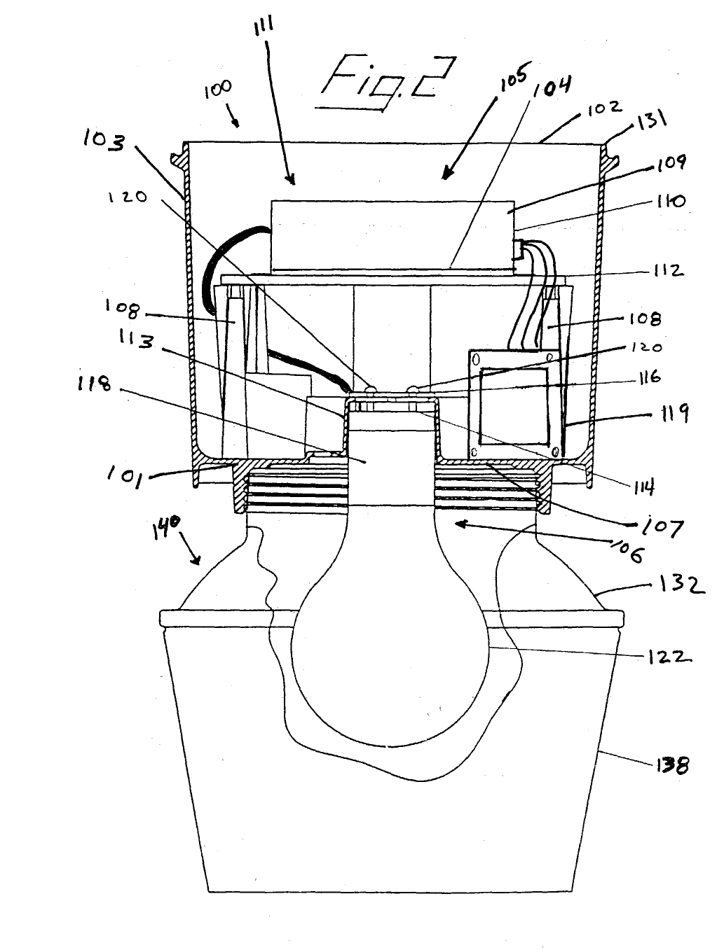

Referring to FIG. 2, a side cross section of a preferred embodiment of the present invention is shown. The induction light fixture 100 has a fixture tank 102 connected to a refractor assembly 140. The fixture tank 102 in a preferred embodiment is the same Hazlux H3® fixture tank which is used in a standard HID fixture. The advantage to using this particular fixture tank 102 is that it can be easily retrofitted onto the appropriate attachments for hazardous lighting assembly.

In a preferred embodiment, the refractor assembly 140 has an aluminum reflector 132 and a refractor glass 138 and are sealably attached to each other and to the fixture tank 102 to create a fluid-tight environment to reduce the possibility of any fluids or ignitable dusts coming into contact with the light.

Fixture tank 102 has a base 101 parametrically bounded by a side wall 103 terminating at a rim 131 to define an interior portion 105. In a preferred embodiment the tank 102 can have a cylindrical configuration. The tank 102 can be made of a metallic material to further dissipate heat. In a preferred embodiment the tank 102 is made of aluminum. The base 101 has a screw socket opening 113 on the outer surface 107. On the interior portion 105 of the tank, at least one tank extension 108 extends substantially perpendicular from the base 101. The tank extensions 108 can be made of the same material of the tank to facilitate manufacturing. Preferably there are four tank extensions 108.

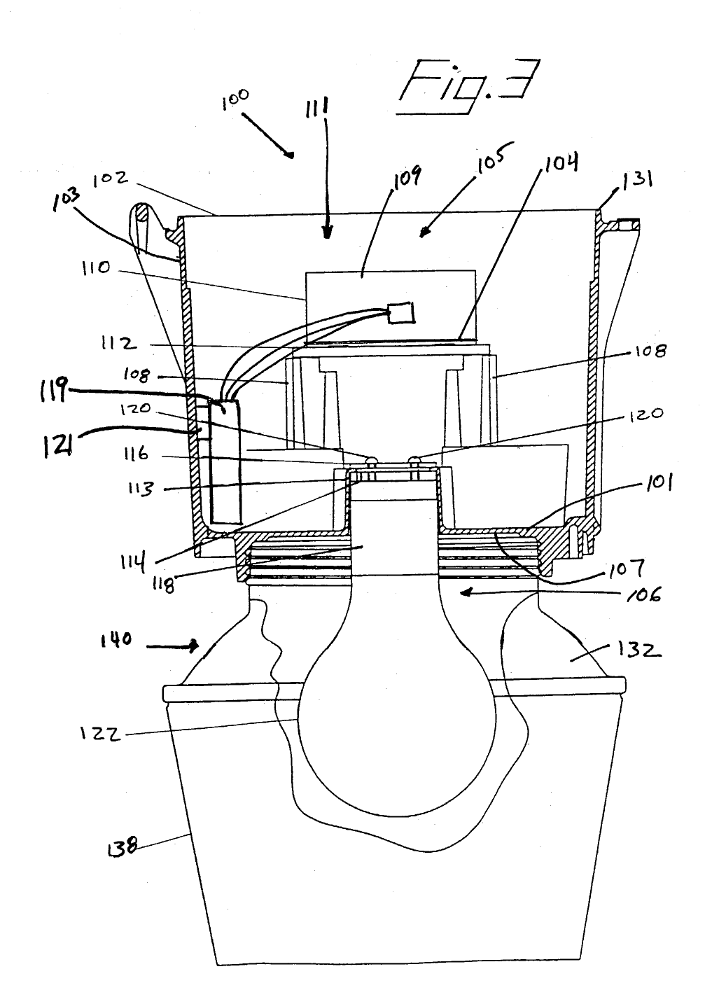

Referring to FIGS. 2 and 3, the induction lighting fixture 100 further includes a ballast mount bracket 112 which is attached to tank extensions 108. The tank extensions 108 are the same tank extensions 18 as in the prior art. The induction lighting fixture further has an induction light assembly 111. The induction light assembly 111 includes the internal workings of the induction light system and electrical hardware and can include a ballast 110 attached to the tank extensions 108. The ballast mount bracket 112 in a preferred embodiment is made of a metallic material and is used as a heat sink and can be made of aluminum. The ballast mount bracket 112 can have a flat plate, rectangular or circular configuration. The ballast 110 enclosure can be made of a metallic material such as aluminum. The advantage to using metal or more particularly aluminum in these two parts is that they act as a heat sink to dissipate heat from lamp 122. In the induction lighting fixture 100, of the present invention utilizes the screw socket 32 of the prior art, however, instead of using the threaded portion of the screw socket 32 of the prior art, only the screw socket opening 113 is used in the present invention.

In a preferred embodiment the ballast 110 can be a high frequency generator 109 which is used with a Phillips QL Induction Light® system. In the preferred embodiment the high frequency generator 109 is mounted on a top surface of the ballast mount bracket 112. The high frequency generator 109 by being placed upon the ballast mount bracket 112 allows the heat generated to be dissipated through the ballast mount bracket 112 and the tank 102. In a more preferred embodiment, a thermal pack 104 is located between the ballast 110 and ballast mount bracket 112 to further assist in dissipating the heat created by the ballast 110.

In a preferred embodiment, there is a lamp mount portion 116 of the tank 102 that is positioned on the upper surface of the screw socket opening 113. Positioned adjacent the lamp mount portion 116 is a lamp mount heat sink 114 positioned in the screw socket opening 113. The lamp mount heat sink 114 is preferably made of aluminum to dissipate heat from the lamp assembly. The thickness of the lamp mount heat sink 114 can be varied to accommodate different types of lamps 122. A further advantage of the lamp mount heat sink 114 is that it can be used as a way to adjust the height of the lamp 122 with respect to the tank 102 if needed. The lamp mount portion 116 and lamp mount heat sink 114 can be attached to each other using several screws 120. Preferably the lamp mount portion 116, lamp mount heat sink 114, ballast mount bracket 112 and ballast 110 are all made of aluminum so as to further help dissipate heat generated by the lamp 122.

In a preferred embodiment a heat sink compound (not shown) can be used between the lamp mount heat sink 114 and the lamp mount portion 116 to further facilitate the transfer of heat from the lamp mount heat sink 114.

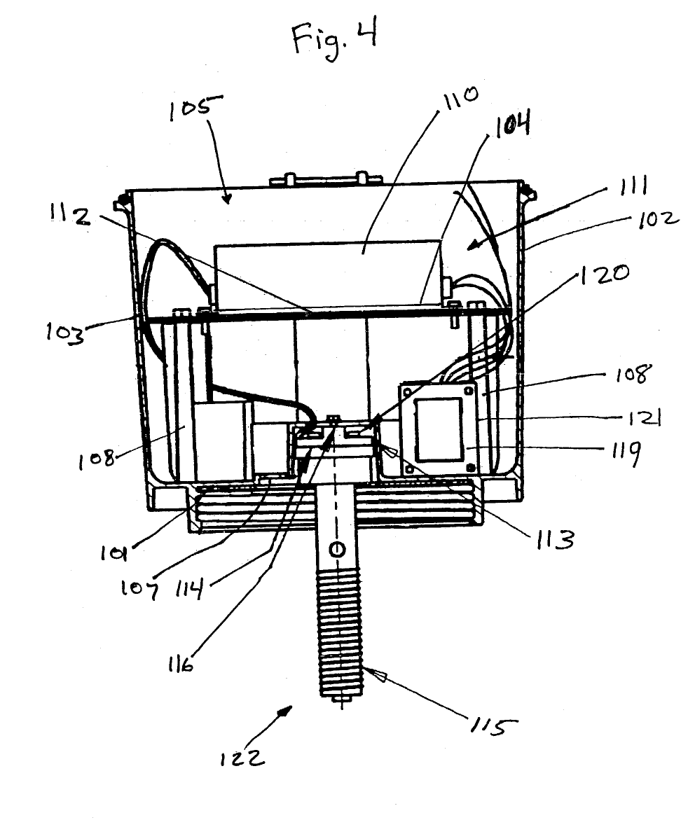

Referring back to FIGS. 2-5, a lamp assembly 106 includes an induction lamp 122 having a mounting portion 118 which fits in the screw socket opening 113 and is attached to the lamp mount heat sink 114 and the lamp mount portion 116 by the use of screws 120. In a preferred embodiment, the lamp 122 can be a Philips QL Induction Light®. The Philips QL Induction Light® has multiple parts. The parts associated with the Philips QL Induction Light® is a power coupler 115 and a bulb 117 which form the lamp 122. The power coupler 115 is used to create a magnetic field to excite particles of a metal vapor which emit ultraviolet radiation. The ultraviolet radiation is converted to visible light as it passes through a fluorescent coating of the bulb 117. The bulb 117 can be made of glass. This particular configuration of the induction lamp 122 is unique to the Philips QL Induction Light® system. The construction of the Philips QL Induction Light® is known in the art. Specifically the power coupler 115 has a mounting portion 118 and is attached to the heat sink 114. Since the power coupler 115 creates heat, this heat must be dissipated through the fixture 100. The power coupler 115 is attached to the lamp mount heat sink 114 using screws 120 or any other method. The glass bulb 117 has a low pressure mercury vapor on the inside to interact with the magnetic field created by the power coupler 115 to emit light. The glass bulb 117 is removably securable to the power coupler 115 during assembly. The power coupler 115 is attached to the lamp mount heat sink 114 and then electrically connected to the high frequency generator 109. It should be noted that an auto transformer 119 may be attached to the interior portion 105 of the tank 102. The auto transformer 119 is electrically connected to the high frequency generator 109. The auto transformer 119 is used to step up or down the supply voltage to a desired voltage to operate the induction light assembly 106. The auto transformer 119 can be attached to the tank 102 by the use of a bracket 121. However, it is envisioned that any type of induction lamp 122 can be used and that the lamp mount portion 116 shape can be modified to accommodate the mounting of a different induction light bulb.

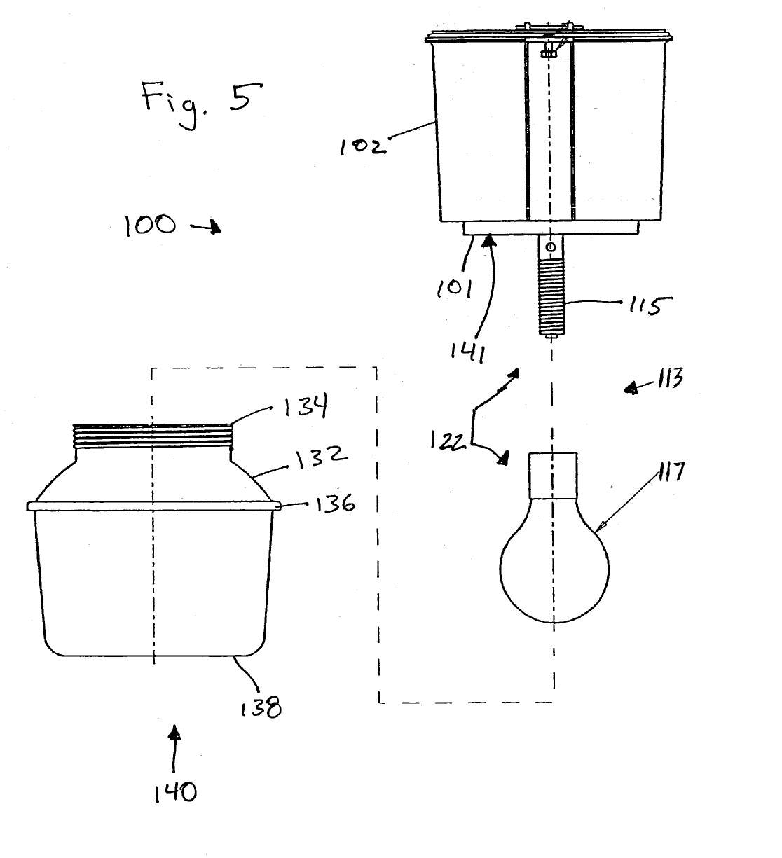

Referring to FIG. 5 the refractor assembly 140, glass bulb 117 and tank 102 are shown in an exploded view. The refractor assembly 140 can include a reflector 132 and a refractor glass 138. The refractor assembly 140 can be removably attached to the base 101 of the tank. In the preferred embodiment the refractor assembly 140 can be threaded at a first end 134 of the reflector 132 to attach to the outer surface of the base 101. In a more preferred embodiment, the refractor assembly 140 is sealably attached to the tank 102 using gasket 141 to create a fluid-tight seal between the refractor assembly 140 and the tank 102. The reflector 132 can be made of an aluminum metal or any heat conductive material to facilitate transfer of any heat created by the induction light from the refractor assembly 140 to the tank 102. The reflector 132 has a second opposite end 136 which is adapted to accommodate a refractor glass 138. The refractor glass 138 can be in any shape and is used to protect the glass bulb 117 of the induction lamp 122. The refractor glass 138 can be attached to the second end 136 of the reflector 132 to create a fluid-tight seal. In a preferred embodiment the refractor glass 138 is translucent or clear to allow light to be emitted from the induction lamp 122.

An advantage to the current system is that the only components which need to be assembled prior to use is the ballast 110, ballast mount bracket 112, lamp mount heat sink 114, lamp mount portion 116 and lamp 122. After assembly only the two lead wires (not shown) from the lamp 122 have to be connected to the ballast 110. With the induction lightings fixture of the present invention, there is no longer any need for the additional items as in the prior art such as a capacitor and igniter which are used for a HID fixture. Furthermore, the mounting brackets associated with the capacitor and igniter are also eliminated from the present design thus making manufacturing much easier and less costly.

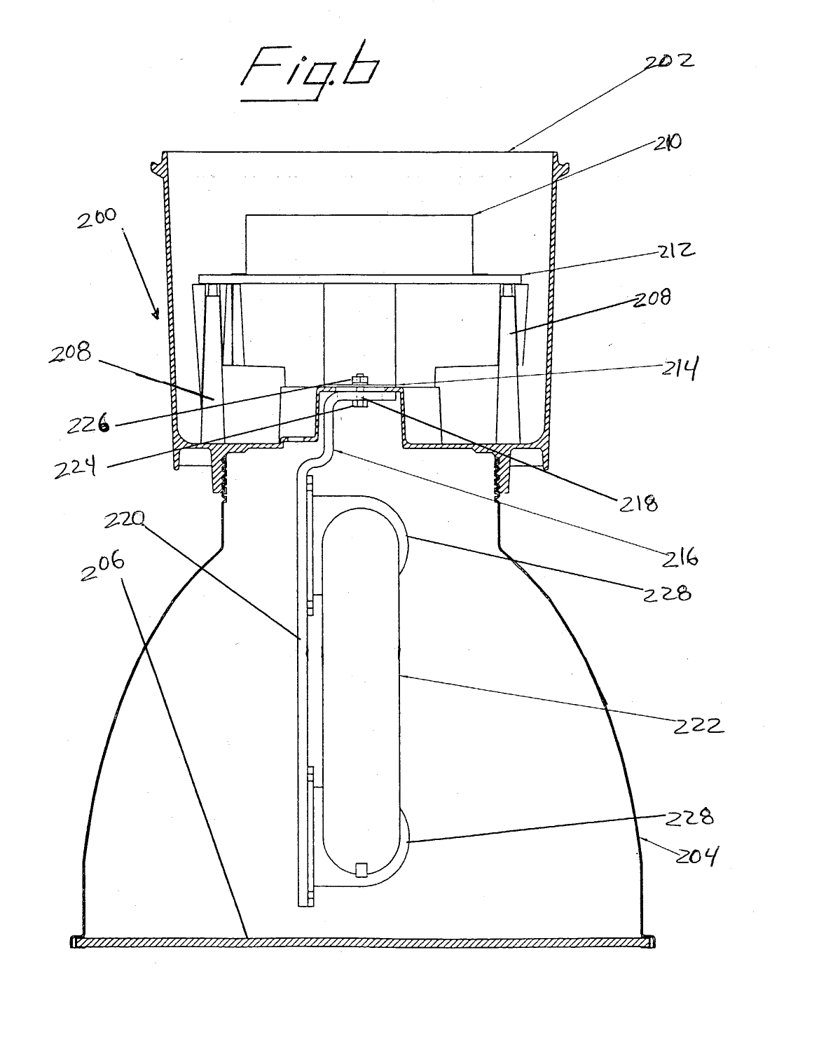

Referring to FIG. 6, a side cross section of an alternative embodiment of the present invention is shown. The induction light fixture 200 has a fixture tank 202 connected to a reflector dome assembly 204. The fixture tank 202 can be a Hazlux H3® fixture tank or similar fixture tank. The refractor assembly 204 and refractor glass 206 are sealably attached to each other and to the fixture tank 202 to reduce the possibility of any flammable dusts coming into contact with the light.

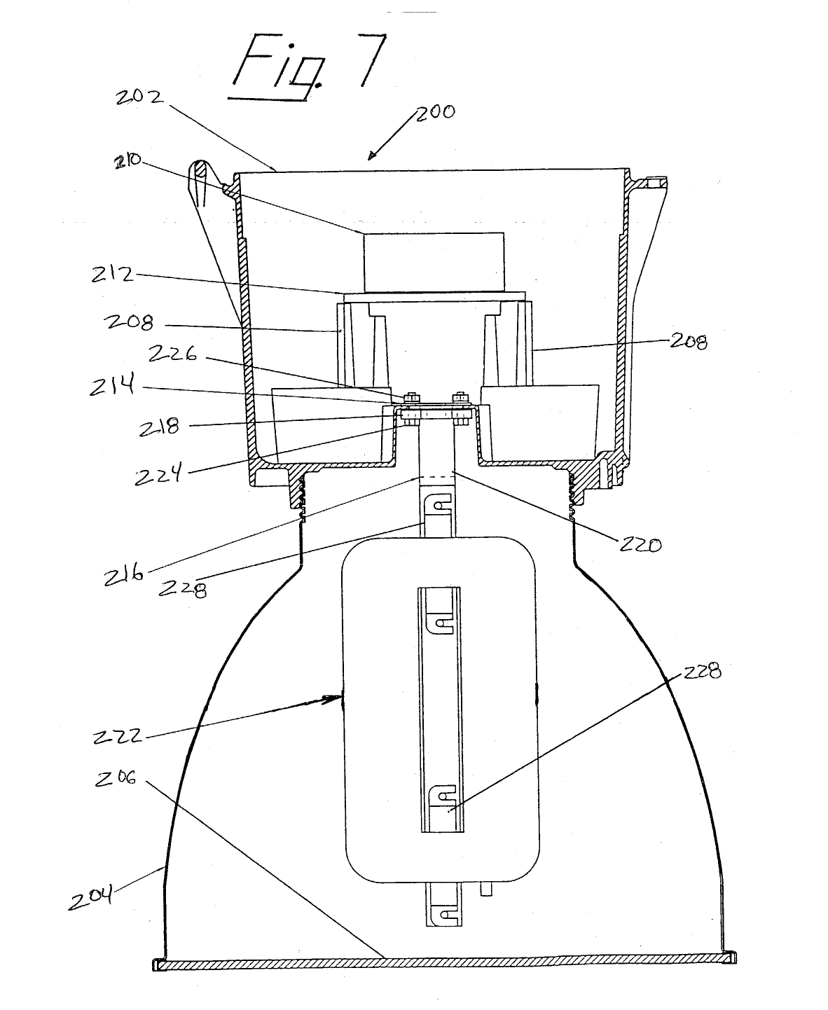

Referring to FIGS. 6 and 7, the induction lighting fixture 200 further includes a ballast mount bracket 212 which is attached to tank extensions 208. The tank extensions 208 are the same tank extensions 18 as in the prior art and extend upwardly from the tank 202. The induction lighting fixture further has a ballast 210 attached to the tank extensions 208. The ballast mount bracket 212 in the preferred embodiment is made of aluminum and has a flat plate configuration. In the preferred embodiment, the ballast 210 is also made of aluminum. The advantage to using aluminum in these two parts is that they act as a heat sink to dissipate heat from lamp 222. In the induction lighting fixture 200, the screw socket 32 of the prior art is not used and instead a plug connector mount 214 is used to attach a lamp bracket 216 which holds the lamp 222.

In the preferred embodiment, the lamp bracket 216 is made of aluminum and has an L-shaped general configuration. The lamp bracket 216 has a first end 218 which is generally perpendicular to a second end 220 to form the L-shape. In the preferred embodiment, the first end 218 is sized to fit within the same space as a screw socket 32 which is used in the prior art, however, the screw socket 32 is now removed and the first end 218 is attached to the plug connector mount 214. The first end 218 can be attached using screws 224 and nuts 226. However, the lamp bracket 216 can be attached to the plug connector mount 214 in any way necessary to create the connection. Preferably, the lamp bracket 216, plug connector 214, ballast mount bracket 212 and ballast 210 are all made of aluminum so as to further help dissipate heat generated by the lamp 222.

Referring back to FIGS. 6 and 7, the lamp 222 is an induction lamp which has mounting feet 228 that are attached to the lamp bracket 216. The mounting feet 228 are preferably connected to the second end 220 of the lamp bracket 216 and allow the heat created by the lamp 222 to be dissipated into the lamp bracket 216 and further to the ballast 210 and ballast mount bracket 212. In a preferred embodiment, the lamp 122 can be a Sylvania Icetron Light® or similarly designed lamp. However, it is envisioned that any type of induction lamp 222 can be used and that the lamp bracket 216 shape can be modified accordingly to accommodate the mounting of a different induction light bulb.

An advantage to the current system is that the only components which need to be assembled prior to use is the ballast 210, ballast mount bracket 212, plug connector 214, lamp bracket 216 and lamp 222. After assembly only the plug connector (not shown) from the lamp 222 have to be connected to the electrical ballast 210. With the induction lightings fixture of the present invention, there is no longer any need for the additional items as in the prior art such as a capacitor and igniter which are used for a HID fixture. Furthermore, the mounting brackets associated with the capacitor and igniter are also eliminated from the present design thus making manufacturing much easier and less costly.

Since the present invention uses the same fixture tank 12 as the prior art design, the induction lighting fixtures 100 and 200 can be easily attached to pre-existing hazardous light fixtures mounts without any further need of modifications in the hazardous light fixture itself.

Although the illustrative embodiments of the present invention have been described herein with reference to the accompanying drawings, it is understood that the invention is not limited to those precise embodiments and that various other changes and modifications may be affected therein by one skilled in the art without departing from the scope or spirit of the invention, and that it is intended to claim all such changes and modifications as fall within the scope of the invention.

1. A light fixture comprising:
a tank having a base with a parametrically extending sidewall terminating at a rim to define an interior portion;
at least one tank extension extending from said base in said interior portion of said tank;
a ballast plate attached to said at least one tank extension;
an induction light assembly attached to said ballast plate and said tank;
an induction lamp operatively connected to said induction light assembly, said induction lamp being positioned on an outer surface of said tank to emit light; and
a refractor assembly selectively securable to said tank on said base to enclose said induction lamp.

2. A light fixture as defined in claim 1, wherein said induction light assembly further includes:
a frequency generator positioned on said ballast plate for electrical connection to said induction lamp; and
a lamp mount heat sink positioned on an outer surface of said base of said tank, wherein said lamp mount heat sink allows for attachment of said induction lamp thereto.

3. A light fixture as defined in claim 2, wherein said induction lamp further includes:
a power coupler to create a magnetic field to operate said induction lamp; and
a glass bulb covering said power coupler to provide a protective covering for said power coupler.

4. A light fixture as defined in claim 3, wherein said refractor assembly is sealably connected to said tank to provide a fluid tight seal.

5. A light fixture as defined in claim 4, wherein said refractor assembly further includes a reflector having a first end being removably attached to said tank, and a second opposite end for receiving a removably attached translucent refractor glass.

6. A light fixture as defined in claim 5, wherein said reflector is made of a metallic material.

7. A light fixture as defined in claim 5, wherein said refractor assembly further includes a gasket seal positioned between said refractor assembly and said tank to provide a fluid tight seal.

8. A light fixture as defined in claim 7, wherein said refractor glass is sealably attached to said reflector to create a fluid tight seal to prevent fluid and dusts from contacting said induction lamp.

9. A light fixture as defined in claim 3, further including an autotransformer electrically connected to said induction light assembly, and a bracket attached to said interior of said tank and providing a surface for attaching said autotransformer.

10. A light fixture as defined in claim 3, wherein said induction light assembly and said induction lamp is a Philips QL Induction Light®.

11. A light fixture comprising:
a tank having a base with a parametrically extending sidewall terminating at a rim to define an interior portion;
at least one tank extension extending from said base in said interior portion of said tank;
a ballast plate attached to said at least one tank extension;
a ballast secured to said ballast plate;
a lamp mount bracket attached to an outer surface of said tank;
an induction lamp operatively connected an electrical source through said tank, said induction lamp being attached to said lamp mount bracket; and
a refractor assembly selectively securable to said tank on said base to enclose said induction lamp.

12. A light fixture as defined in claim 11, wherein said induction light assembly and said induction lamp is a Sylvania Icetron Light®.
